(19) United States
(12) Patent Application Publication
(10) Pub. No.: US 2002/0009598 A1
(43) Pub. Date: Jan. 24, 2002

(54) SCRATCH RESISTANT COLOR MATCH LAMINATE

(76) Inventors: ROBERT LAFAVE, BIRCH RUN, MI (US); ROBERT BOWLING, DECKERVILLE, MI (US)

Correspondence Address: PHILIP R. WARN, ESQ., WARN IP LAW OFFICE, P.O. BOX 70098, ROCHESTER HILLS, MI, 48307, US

(21) Appl. No.: 09/244,831

(22) Filed: Feb. 4, 1999

(51) Int. Cl. B32B 27/08; B32B 27/40

(52) U.S. Cl. 428/421; 428/424.2; 428/424.4; 428/516; 428/520

(57) ABSTRACT

A laminate product for use as a protective and decorative sheet material for application to a substrate is described. The laminate product is comprised of: (1) a base coat layer comprising a colorant-containing thermoplastic resin system, the colorant being substantially uniformly distributed throughout the colorant-containing thermoplastic resin system; (2) a top coat layer; and (3) an adhesion promoting layer disposed between the base coat layer and the top coat layer. The colored base coat layer permits deeper draws for the formation of highly contoured components such as automotive bumpers and fascias, without the loss of color intensity or scratch resistance.

### FIELD OF THE INVENTION

The present invention relates in general to laminated products and methods of making the same, and in particular to flexible, thermoformable laminated sheet materials that can be attached to various substrates, including exterior automotive body panels and trim parts, as a protective and decorative covering, and methods of making the same.

### BACKGROUND OF THE INVENTION

The advent of exterior automotive body panels and trim parts comprised of thermoplastic materials has enabled manufacturers to reduce assembly costs, production time, and fuel consumption rates of modern automobiles, as compared to older automobile models that incorporated large amounts of sheet metal into their designs. However, the use of these thermoplastic exterior automotive body panels and trim parts also required manufacturers to employ painting techniques that produced panels and parts that have acceptable physical properties that are important to consumers, such as gloss; distinctiveness-of-image; hardness; abrasion or scratch resistance; weatherability such as UV resistance; impact strength; thermal stability, namely, resistance to extreme high and low temperatures; gasoline and acid resistance; cleanability; adhesion to the underlying car body panel; resistance to water and humidity exposure; and hiding ability or opacity of the paint coat. Accordingly, there has been significant interest on the part of manufacturers to produce a protective and decorative coating on these panels and parts that will meet or exceed consumers demands and expectations.

The traditional painting technique for thermoplastic exterior automotive body panels and trim parts involved spray painting which produced potentially dangerous levels of airborne pollutants, wasted significant amounts of paint, and resulted in unacceptable variations in quality control. Because of these disadvantages, there has been a growing trend toward eliminating the need for the spray painting operation, in favor of more efficient and economical alternatives.

One approach has involved the use of a preformed thermoplastic sheet material that can be bonded, attached, or otherwise fastened to the panel or part to provide the requisite protective and decorative coating that will equal or exceed the quality of a conventionally spray-painted surface. However, exterior automotive panels and trim parts present a particular problem in view of the difficulty of smoothly adhering a flexible sheet material to a curved substrate and the difficulty of doing so while maintaining a uniform color intensity over the entire surface. This is even more problematic when metallic colors are desired in finishes.

Discussions of various laminated products, the materials employed, and the methods of making the same may be found in U.S. Pat. Nos. 4,810,540 to Ellison et al.; 4,832,991 to Hayward et al.; 4,900,611 to Carroll, Jr.; 4,921,556 to Hakiel et al.; 4,913,760 to Benson et al.; 4,913,970 to Hayward et al.; 4,918,800 to Reafler; 4,921,755 to Carroll, Jr. et al.; 4,931,324 to Ellison et al.; 4,933,237 to Krenceski et al.; 4,943,680 to Ellison et al.; 5,026,448 to Reafler et al.; 5,034,077 to Pata; 5,034,269 to Wheeler; 5,034,275 to Pearson et al.; 5,035,940 to Winton et al.; 5,100,728 to Plamthottam et al.; 5,114,514 to Landis; 5,114,789 to Reafler; 5,118,372 to Spahn; 5,125,994 to Harasta et al.; 5,132,148 to Reafler; 5,165,976 to Newing et al.; 5,192,609 to Carroll, Jr.; 5,215,811 to Reafler et al.; 5,215,826 to Shimanski et al.; 5,268,215 to Krenceski et al., 5,286,528 to Reafler; 5,318,815 to Newing et al.; 5,342,666 to Ellison et al.; 5,514,427 to Ellison et al.; 5,518,786 to Johnson et al.; 5,536,539 to Ellison et al.; 5,539,057 to Giroux; 5,574,094 to Malucelli; 5,585,434 to DeNicola et al.; 5,585,448 to Resconi et al.; 5,593,759 to Vargas et al.; 5,653,927 to Flynn et al.; 5,698,487 to Sacchetti et al.; 5,707,697 to Spain et al.; 5,725,712 to Spain et al.; 5,750,234 to Johnson et al., 5,759,940 to Sacchetti et al.; 5,817,707 to DeNicola et al.; 5,849,653 to Dall'Occo et al.; and 5,859,104 to Becker, the entire specifications of which are expressly incorporated herein by reference.

Some manufacturers have attempted to produce a flexible and stretchable sheet material having these capabilities through the application of one or more paint layers to the surface of a thermoformable thermoplastic support. However, it is believed that these efforts have resulted in products having numerous coating defects and in which the paint layer does not have the high degree of uniformity which permits the sheet material to undergo the stresses of thermoforming and yet meet the exacting standards of an exterior automotive finish. Thus, the amount and depth of draw is limited, thus representing a limitation on the types and configurations of exterior automotive panels and trim parts that may be produced with these sheet materials.

Several polyolefin resin manufacturers have developed “mold in” color resins for exterior automotive parts that can be injection molded. The problem that occurs with these “mold in” color resins is that the outermost surfaces are relatively soft due to the nature of the resin, and thus are easily scratched, or otherwise blemished. Another problem that occurs with these “mold in” color resins is gloss level retention during the injection molding process.

In order to overcome these disadvantages, manufacturers have recently employed a film comprised of a scratch resistant layer having one or more layers of paint, ink, or other colorants applied to one surface thereof. This colored, scratch resistant laminated product is then bonded, attached, or otherwise fastened to the underlying thermoplastic substrate to form the finished exterior automotive panel or trim part. However, the process of applying paint, ink, or other colorants to the scratch resistant layers may potentially produce defects and unnecessarily adds to manufacturing costs, especially with respect to solvent-based paints, inks, and other colorants. Additionally, the paint, ink, or other colorant will have a tendency to wash or fade because of the stress from stretching of the film during thermoforming.

Therefore, there exists a need for a flexible, thermoformable laminated sheet material and method of making the same, that can be attached to various substrates, including exterior automotive body panels and trim parts, as a protective and decorative covering, wherein the sheet material can be formed into various shapes and configurations while retaining uniform color intensity and scratch resistance.

### SUMMARY OF THE INVENTION

In accordance with one embodiment of the present invention, the present invention provides a protective and decorative sheet material for application to substrates comprised of: (1) a base coat layer comprising a colorant-containing thermoplastic resin system, the colorant being substantially uniformly distributed throughout the colorant-containing thermoplastic resin system; (2) a top coat layer; and (3) an adhesion promoting layer disposed between the base coat layer and the top coat layer.

In accordance with another embodiment of the present invention, the present invention provides a laminate product comprised of: (1) a substrate; (2) a base coat layer adjacent to the substrate, the base coat layer comprising a colorant-containing thermoplastic resin system, the colorant being substantially uniformly distributed throughout the colorant-containing thermoplastic resin system; (3) a top coat layer; and (4) an adhesion promoting layer disposed between the base coat layer and the top coat layer.

In accordance with another embodiment of the present invention, the present invention provides a protective and decorative sheet material for application to substrates comprised of: (1) a base coat layer comprising a colorant-containing thermoplastic resin system, the colorant being substantially uniformly distributed throughout the colorant-containing thermoplastic resin system, and a chlorinated compound applied to at least a portion of at least one surface of the base coat layer; and (2) a top coat layer disposed on the at least one surface of the base coat layer having the chlorinated compound applied thereto.

In accordance with another embodiment of the present invention, the present invention provides a protective and decorative sheet material for application to substrates comprised of: (1) a base coat layer comprising a colorant-containing thermoplastic resin system, the colorant being substantially uniformly distributed throughout the colorant-containing thermoplastic resin system, and a chlorinated compound mixed throughout the colorant-containing thermoplastic resin system; and (2) a top coat layer disposed on the base coat layer.

In accordance with another embodiment of the present invention, the present invention provides a laminate product comprised of: (1) a substrate; (2) a base coat layer adjacent to the substrate, the base coat layer comprising a colorant-containing thermoplastic resin system, the colorant being substantially uniformly distributed throughout the colorant-containing thermoplastic resin system; a chlorinated compound applied to at least a portion of at least one surface of the base coat layer; and (3) a top coat layer disposed on the at least one surface of the base coat layer having the chlorinated compound applied thereto.

In accordance with another embodiment of the present invention, the present invention provides a laminate product comprised of: (1) a substrate; (2) a base coat layer adjacent to the substrate, the base coat layer comprising: a colorant-containing thermoplastic resin system, the colorant being substantially uniformly distributed throughout the colorant-containing thermoplastic resin system, and a chlorinated compound mixed throughout the colorant-containing thermoplastic resin system; and (3) a top coat layer disposed on the base coat layer.

In accordance with another embodiment of the present invention, the present invention provides a method of making a protective and decorative sheet material for application to a substrate comprising the steps of: (1) providing a base coat layer comprising a colorant-containing thermoplastic resin system, the colorant being substantially uniformly distributed throughout the colorant-containing thermoplastic resin system; (2) providing an adhesion promoting layer; (3) laminating the adhesion promoting layer onto the base coat layer; (4) providing a top coat layer; and (5) laminating the top coat layer onto the adhesion promoting layer.

In accordance with another embodiment of the present invention, the present invention provides a method of making a laminate product comprising the steps of: (1) providing a base coat layer comprising a colorant-containing thermoplastic resin system, the colorant being substantially uniformly distributed throughout the colorant-containing thermoplastic resin system; (2) providing an adhesion promoting layer; (3) laminating the adhesion promoting layer onto the base coat layer; (4) providing a top coat layer; (5) laminating the top coat layer onto the adhesion promoting layer to form a laminate product; (6) providing a substrate; and (7) joining the laminate product to the substrate.

In accordance with another embodiment of the present invention, the present invention provides a method of making a protective and decorative sheet material for application to a substrate, comprising the steps of: (1) providing a base coat layer comprising a colorant-containing thermoplastic resin system, the colorant being substantially uniformly distributed throughout the colorant-containing thermoplastic resin system, and a chlorinated compound applied to at least a portion of at least one surface of the base coat layer; (2) providing a top coat layer; and (3) laminating the top coat layer onto the at least one surface of the base coat layer having the chlorinated compound applied thereto.

In accordance with another embodiment of the present invention, the present invention provides a method of making a protective and decorative sheet material for application to a substrate, comprising the steps of: (1) providing a base coat layer comprising a colorant-containing thermoplastic resin system, the colorant being substantially uniformly distributed throughout the colorant-containing thermoplastic resin system, and a chlorinated compound mixed throughout the colorant-containing thermoplastic resin system; (2) providing a top coat layer; and (3) laminating the top coat layer onto the base coat layer.

In accordance with another embodiment of the present invention, the present invention provides a method of making a laminate product, comprising the steps of: (1) providing a base coat layer comprising a colorant-containing thermoplastic resin system, the colorant being substantially uniformly distributed throughout the colorant-containing thermoplastic resin system, and a chlorinated compound applied to at least a portion of at least one surface of the base coat layer; (2) providing a top coat layer; (3) laminating the top coat layer onto the at least one surface of the base coat layer having the chlorinated compound applied thereto to form a laminate product; (4) providing a substrate; and (5) joining the laminate product to the substrate.

In accordance with another embodiment of the present invention, the present invention provides a method of making a laminate product, comprising the steps of: (1) providing a base coat layer comprising a colorant-containing thermoplastic resin system, the colorant being substantially uniformly distributed throughout the colorant-containing thermoplastic resin system, and a chlorinated compound mixed throughout the colorant-containing thermoplastic resin system; (2) providing a top coat layer; (3) laminating the top coat layer onto the base coat layer to form a laminate product; (4) providing a substrate; and (5) joining the laminate product to the substrate.

A more complete appreciation of the various embodiments. and aspects of the present invention and the scope thereof can be obtained from a study of the accompanying drawings, which are briefly summarized below, the following detailed description of the invention, and the appended claims.

### BRIEF DESCRIPTION OF THE DRAWING

FIG. 1 is an enlarged partial cross-sectional view of a sheet material of the present invention.

FIG. 2 is a partial perspective view illustrating a method of making the sheet material of FIG. 1.

The same reference numerals refer to the same parts throughout the various Figures.

### DETAILED DESCRIPTION OF THE PREFERRED EMBODIMENTS

The invention will be described with reference to providing protective and decorative finishes on exterior automotive panels and trim parts, such as but not limited to, bumpers, fascias, doors, hoods, trunks, mirror housings and body side moldings. However, it should be understood that there are many other substrates to which the sheet material of the invention can be applied.

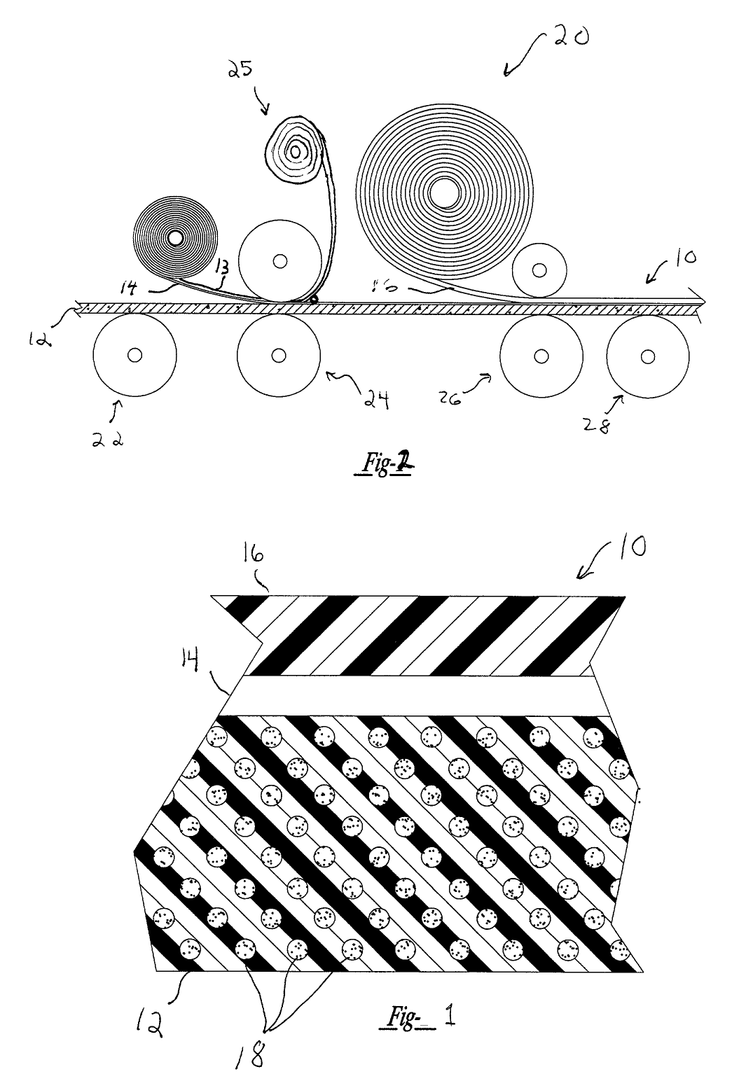

Referring to FIG. 1, the laminate product or sheet material 10 of the present invention is comprised primarily of a base coat layer 12, an adhesion promoting layer 14, and a top coat 16. The sheet material 10 is preferably flexible and thermoformable.

The base coat layer 12 is preferably comprised of a colorant-containing thermoplastic resin system, with the colorant 18 being substantially uniformly distributed throughout the colorant-containing thermoplastic resin system. By distributing a sufficient quantity of colorant throughout the thermoplastic resin system, the base coat layer 12 is rendered substantially opaque, even after significant stretching of the sheet material 10 has occurred, for example, during thermoforming.

By the term “color-containing thermoplastic resin system” as used herein is meant a system that comprises at least two elements: (1) at least one pigment or dye; and (2) at least one thermoplastic material. Other compounds, materials or agents may be employed in this system as well, especially those conventionally used in coloring thermoplastic resins or in formulating color concentrates. By way of example (but without any suggestion of limitation) the color-containing thermoplastic resin systems useful in the present invention may additionally employ a plurality of organic or inorganic pigments, dyes, or mixtures thereof. These may be incorporated into the thermoplastic resin as conventional dry or liquid color concentrates, super-concentrates, or pre-colored resin systems. Additionally, other optional materials may be added to the color-containing thermoplastic resin system including, but not limited to, additives such as antioxidants, antiozonants, and ultraviolet absorbers; coupling agents; curing agents; flame retardants; heat stabilizers; impact modifiers; lubricants; plasticizers; preservatives; processing aids; reinforcements; and fillers.

Preferably, the thermoplastic material of the base coat layer 12 is comprised of one or more types of polyolefins. Polyolefins are generally defined as resinous materials made by the polymerization of olefins, such as polyethylene from ethylene, polypropylene from propylene, polybutene from butylene, and so on. Polyolefins are generally characterized as having good chemical resistance, stress cracking resistance, weatherability, reduced density, improved processability, and enhanced ductility. Although polyolefins are preferred, other materials such as nanocomposites based on clay materials (e.g., smectite clay) are also useful in the practice of the present invention.

In accordance with a preferred embodiment of the present invention, the thermoplastic material of the base coat layer 12 is comprised of polypropylene, or alternatively one or more types of olefenic alloys, such as, but not limited to, acrylic-based or styrenic-based olefinic resin alloys. Additionally, other materials such as, but not limited to, acrylics, polycarbonates, acrylonitrile-butadiene-styrene (ABS), and nylon may be used as the thermoplastic material of the base coat layer 12.

In accordance with a highly preferred embodiment of the present invention, the base coat layer 12 is comprised of either HIVALLOY W™ or HIVALLOY G™ (readily commercially available from Montell Technology Company BV, Hoofddorp, Netherlands), BEXLOY™ W (readily commercially available from E. I. du Pont de Nemours and Company, Wilmington, Del.), or DEXFLEX™ E-1501 TF (readily commercially available from Solvay Engineered Polymers, Auburn Hills, Mich.).

The general properties of the HIVALLOY W™ and HIVALLOY G™ brand materials are presented in Table I, below:

TABLE I

| General | | | |
|---|---|---|---|
| Properties | ASTM | Units | Value |
| Specific Gravity | D792 | g/cc | 0.91 to 0.98 |
| Tensile Strength | D638 | psi | 3000 to 5200 |
| Elongation @ | D638 | % | 20 to >400 |
| Break | | | |
| Elongation @ | D638 | % | 6 to 25 |
| Yield | | | |
| Flexural Modulus | D790A | kpsi | 110 to 280 |
| Flexural Strength | D790A | psi | 3000 to 7900 |
| HDT @ 66 psi | D648 | ° F. | 170 to 205 |
| HDT @ 264 psi | D648 | ° F. | 118 to 140 |
| Notched Izod @ | D256 | ft-lb/in | 1.0 to 8.0 |
| 73° F. | | | |
| MFR (230/3.8) | D1238 | dg/min | 2 to 25 |
| CLTE | D696 | | 4.1 to 9.5 |
| Water Absorption | | % | <0.2 to <0.5 |
| Mold Shrinkage | D955 | in/in | .008 to .016 |

The general properties of the BEXLOY™ W brand material are presented in Table II, below:

TABLE II

| General | | | | | |
|---|---|---|---|---|---|
| Properties | ASTM | Units | Temperature | | Value |
| Flexural | D790 | MPa | 23° | C. | 682 |
| Modulus | | kpsi | 73° | F. | 100 |
| Specific | D792 | | 23° | C./73° F. | 0.97 |
| Gravity | | | | | |
| Tensile | D638 | MPa | 23° | C. | 20 |
| Strength | | psi | 73° | F. | 2900 |
| Elongation @ | D638 | % | 23° | C./73° F. | >400 |
| Break | | | | | |
| Heat Sag | D3769 | mm | 82° | C. | 13 |
| | | inches | 180° | F. | 0.5 |
| Tear | D624 | kN/m | 23° | C. | 164 |
| Resistance | | lb/in | 73° | F. | 935 |
| Notched Izod | D256 | J/m | −30° | C. | 854 |
| Impact | | ft · lb/in | −22° | F. | 16 |
| Gardner | D3029 | J | −30° | C. | >36 |
| Impact | | in · lb | −22° | F. | >320 |
| Rheometric | | J | 23° | C. | 22 |
| Impact | | in · lb | 73° | F. | 194 |
| | | J | −30° | C. | 18 |
| | | in · lb | −22° | F. | 159 |
| Shrinkage | D955 | % | | | 1.2 |
| Coefficient | D831 | μm/m, ° C. | −30° to | 80° C. | 84 |
| of Linear | | in/in, ° F. | −22° to | 176° F. | 4.6 × 10⁻⁵ |
| Thermal | | | | | |
| Expansion | | | | | |

The general properties of the DEXFLEX™ E-1501 TF brand material are presented in Table III, below:

TABLE III

| General | | | |
|---|---|---|---|
| Properties | ASTM | Units | Value |
| Hardness | D2240 | Shore D | 65 |
| Specific Gravity | D792 | | 0.95 |
| Melt Flow Rate | D1238 | g/10 min | 0.92 |
| Flexural Modulus | D790 | kpsi | 150 |
| Tensile Strength | D638 | psi | 3800 |
| Elongation @ | D638 | % | 500 |
| Break | | | |
| Tear Strength | D1004 | lb/in | 700 |
| Gardner Impact | D3028 | in · lb | >300 |
| @ −30° C. | | | |

The base coat layer 12 is preferably formed into thin flexible sheets or rolls in preparation for the lamination process which will be described in detail herein. The thickness of the base coat layer 12 is preferably in the range of about 0.010 inches to about 0.250 inches. In accordance with a preferred embodiment of the present invention, the thickness of the base coat layer 12 is preferably in the range of about 0.020 inches to about 0.060 inches. It should be noted that the base coat layer 12 may be configured to any desired

The general properties of the DEXFLEX™ E-1501 TF brand material are presented in Table III, below:

TABLE III

| General | | | |
|---|---|---|---|
| Properties | ASTM | Units | Value |
| Hardness | D2240 | Shore D | 65 |
| Specific Gravity | D792 | | 0.95 |
| Melt Flow Rate | D1238 | g/10 min | 0.92 |
| Flexural Modulus | D790 | kpsi | 150 |
| Tensile Strength | D638 | psi | 3800 |
| Elongation @ | D638 | % | 500 |
| Break | | | |
| Tear Strength | D1004 | lb/in | 700 |
| Gardner Impact | D3028 | in · lb | >300 |
| @ −30° C. | | | |

The base coat layer 12 is preferably formed into thin flexible sheets or rolls in preparation for the lamination process which will be described in detail herein. The thickness of the base coat layer 12 is preferably in the range of about 0.010 inches to about 0.250 inches. In accordance with a preferred embodiment of the present invention, the thickness of the base coat layer 12 is preferably in the range of about 0.020 inches to about 0.060 inches. It should be noted that the base coat layer 12 may be configured to any desired thickness depending on the particular application.

In order to secure the top coat layer 16 to the base coat layer 12, it is generally necessary to employ an adhesion promoting layer 14 that is disposed therebetween. In this manner, the top coat layer 16 and the base coat layer 12 do not come into contact with one another. Rather, it is the adhesion promoting layer 14 that actually allows for the formation of the laminate product 10 of the present invention. The adhesion promoting layer 14 (also referred to as a tie layer, adhesive primer layer, etc.) is generally comprised of an adhesive material that is capable of adhering to both the top coat layer 16 and the base coat layer 12. Therefore, the adhesion promoting layer 14 must be comprised of material or materials that are compatible with the top coat layer 16 and the base coat layer 12 in order to achieve the desired degree of adhesion between the particular layers. Preferably the adhesive material is completely, or at least substantially, transparent so as not to obscure the colorant contained in the base coat layer 12.

In accordance with a preferred embodiment of the present invention, the adhesion promoting layer 14 is comprised of a chlorinated polyolefin/acrylic material. In accordance with a highly preferred embodiment of the present invention, the adhesion promoting layer 14 is actually comprised of two discrete layers wherein the first layer is comprised of chlorinated polyolefin and the second layer is comprised of acrylic material. An example of a suitable two layer system of this type is readily commercially available from Maple Roll Leaf (Windsor, Ontario, Canada) under the product designation X-275. The X-275 material, which is proprietary in nature, is comprised of a layer of modified chlorinated polyolefin and an adjacent layer of a high molecular weight acrylic copolymer. It should be noted that standard adhesives additives, such as magnesium silicate, may be added to the adhesion promoting layer 14 to enhance its performance and appearance. During the lamination process, it is intended that the chlorinated polyolefin layer is placed against the base coat layer 12, and the acrylic layer is placed against the top coat layer 16.

The adhesion promoting layer 14 is preferably formed into thin flexible sheets or rolls in preparation for the lamination process which will be described in detail herein. The thickness of the adhesion promoting layer 14 is preferably in the range of about 0.03 grams/m² to about 1.5 grams/m², still more preferably in the range of about 0.1 grams/m² to about 1.0 gram/m², and most prefereably in the range of about 0.3 grams/m² to about 0.5 grams/m². It should be noted that other thicknesses are envisioned depending on the particular application.

The top coat layer 16 is preferably completely, or at least substantially, transparent so as not to obscure the colorant contained in the base coat layer 12. Additionally, the top coat layer 16 is preferably highly scratch resistant so as to avoid nicks, scrapes, an other blemishes from forming on the surface of the laminate product 10 of the present invention. In accordance with a preferred embodiment of the present invention, the top coat layer 16 is comprised of a thermoplastic material, such as, but not limited to, polyvinylidene fluoride (PVDF), readily commercially available under the tradename KYNAR™ from San Diego Plastics, Inc. (San Diego, Calif.), polyvinyl fluoride (PVF), readily commercially available under the tradename TEDLAR™ from E. I. du Pont de Nemours and Company (Wilmington, Del.), or acrylic, readily commercially available under the tradename KORAD™ from Polymer Extruded Products (Newark, N.J.). Alternatively, polyurethane, especially cross-linked polyurethane, may be used as the top coat layer 16.

The top coat layer 16 is preferably formed into thin flexible sheets or rolls in preparation for the lamination process which will be described in detail herein. The thickness of the top coat layer 16 is preferably in the range of about 0.0005 inches to about 0.010 inches. In accordance with a preferred embodiment of the present invention, the thickness of the top coat layer 16 is in the range of about 0.001 inches to about 0.005 inches. It should be noted that other thicknesses may be employed, depending on the particular application.

In accordance with another embodiment of the present invention, a coating of chlorinated compound (e.g., chlorinated polyolefin) is applied (e.g., rolling, spraying, etc.) onto the top surface of the base coat layer 12, instead of applying the previously described adhesion promoting layer 14. The top coat layer 16 is then directly applied onto the coated top surface of the base coat layer 12. The chlorinated compound must be compatible with both the base coat layer 12 and the top coat layer 16 in order to achieve the desired degree of adhesion between the two layers.

In accordance with yet another embodiment of the present invention, the chlorinated compound (e.g., chlorinated polyolefin) is mixed throughout the base coat layer 12, instead of only being applied to the top surface thereof. The top coat layer 16 is then applied onto the top surface of the base coat layer 12. As previously mentioned, the chlorinated compound must be compatible with both the base coat layer 12 and the top coat layer 16 in order to achieve the desired degree of adhesion between the two layers.

To illustrate the enhanced scratch resistance of the top coat layer 16 of the present invention, a specimen of the laminate product 10 of the present invention was submitted to an independent laboratory for analysis. A crock mar resistance test was performed in accordance with Chrysler laboratory procedure LP-463PB-54-01. Dry BON-AMI™ cleanser was applied to approximately one half of the specimen which was then rubbed with a 5×5 centimeter wool felt cloth for ten times using an Atlas AATCC mar tester. The specimen's original 20° gloss was 62.3, whereas the marred 20° gloss was 40.2. Therefore, the mar resistance (marred/original gloss×100) was 64.5.

Referring to FIG. 2, the manufacture of the laminate product 10 of the present invention will now be described in detail. Preferably, the base coat layer 12, adhesion promoting layer 14, and top coat 16 are in roll form and are mounted on the axles of a conventional laminating apparatus 20, preferably employing quartz heated silicone rolls.

In this view, the base coat layer 12 is being fed through one end of the laminating apparatus 20 by the action of one or more roller assemblies 22. The head pressure is preferably in the range of about 60 to about 120 pounds per square inch. The feed speed may vary; however, about 10 to about 15 feet per minute is preferable. As the base coat layer 12 advances, the roll containing the adhesion promoting layer 14 is actuated so as to apply the adhesion promoting layer 14 onto the top surface of the base coat layer 12.

The base coat layer 12/adhesion promoting layer 14 laminate is then fed through a heated (e.g., 390-500° F.) calendering roller assembly 24 to ensure that a strong bond (chemical and/or physical) is established between the base coat layer 12 and the adhesion promoting layer 14. The top surface of the adhesion promoting layer 14 is preferably provided with a releasable liner 13 so as to prevent the top surface of the adhesion promoting layer 14 from sticking to the roller assembly 24. Once the base coat layer 12/adhesion promoting layer 14 laminate is fed through the roller assembly 24, a rewind mechanism 25 removes the liner 13 from the top surface of the adhesion promoting layer 14 in preparation for the application of the top coat layer 16.

As the base coat layer 12/adhesion promoting layer 14 laminate advances, the roll containing the top coat layer 16 is actuated so as to apply the top coat layer 16 onto the top surface of the adhesion promoting layer 14. The base coat layer 12/adhesion promoting layer 14/top coat layer 16 laminate is then fed through a heated (e.g., 390-500° F.) calendering roller assembly 26 to ensure that a strong bond (chemical and/or physical) is established between the top coat layer 16 and the adhesion promoting layer 14. In this manner the laminate product 10 of the present invention is formed and fed further down the line by an additional roller 28.

The laminate product 10 of the present invention can be processed in any number of ways, including, but not limited to thermoforming, vacuum forming, and insert molding. As the laminate product 10 is in the form of a relatively thin and flexible sheet, it can easily be adapted to the contours of various thermoplastic or metallic substrates, such as, but not limited to automotive body panels and trim parts. Additionally, because the laminate product 10 is thermoformable, it may be shaped into a number of complex configurations and then placed into an injection molding apparatus whereupon a substrate (e.g., thermoplastic resin) may be laminated or otherwise bonded to the laminate product 10 of the present invention. In this manner, complex, yet sturdy components may be quickly and inexpensively made without compromising quality or safety. For example, the laminate product 10 of the present invention will allow thicker laminates to be formed in deep draw areas like bumpers and fascias, and would be thick enough to be structurally stable without insert molding. It will be appreciated that the depth of draw is dependent on several factors, including, but not limited to, the thickness of the base coat layer of the laminate product as well as the thickness of any substrate to which the laminate product is joined to. For instance, if there is “read-through” or discontinuity in opacity in the laminate product, the thickness of the base coat layer can be increased, or alternatively, a similarly colored thermoplastic resin can be injection molded behind the laminate product.

The foregoing detailed description shows that the preferred embodiments of the present invention are well suited to fulfill the objects above-stated. It is recognized that those skilled in the art may make various modifications or additions to the preferred embodiments chosen to illustrate the present invention without departing from the spirit and proper scope of the invention. Accordingly, it is to be understood that the protection sought and to be afforded hereby should be deemed to extend to the subject matter defined by the appended claims, including all fair equivalents thereof.

What is claimed is:

1. A protective and decorative sheet material for application to substrates, comprising:
a base coat layer comprising a colorant-containing thermoplastic resin system, the colorant being substantially uniformly distributed throughout the colorant-containing thermoplastic resin system;
a top coat layer; and
an adhesion promoting layer disposed between the base coat layer and the top coat layer.

2. The sheet material of claim 1, wherein the base coat layer has an elongation at break in the range of up to about 500 percent as determined by ASTM D638.

3. The sheet material of claim 1, wherein the base coat layer is substantially opaque.

4. The sheet material of claim 1, wherein the colorant-containing thermoplastic resin system is comprised of materials selected from the group consisting of pigments, dyes, and combination thereof.

5. The sheet material of claim 1, wherein the colorant-containing thermoplastic resin system is comprised of a polyolefin.

6. The sheet material of claim 1, wherein the colorant-containing thermoplastic resin system is comprised of polypropylene.

7. The sheet material of claim 1, wherein the top coat layer is substantially transparent.

8. The sheet material of claim 1, wherein the top coat layer is scratch resistant.

9. The sheet material of claim 1, wherein the top coat layer is comprised of a thermoplastic material.

10. The sheet material of claim 1, wherein the top coat layer is comprised of polyvinylidene fluoride.

11. The sheet material of claim 1, wherein the top coat layer is comprised of polyurethane.

12. The sheet material of claim 1, wherein the top coat layer is comprised of cross-linked polyurethane.

13. The sheet material of claim 1, wherein the adhesion promoting layer is comprised of a polyolefin.

14. The sheet material of claim 1, wherein the adhesion promoting layer is comprised of a chlorinated polyolefin.

15. The sheet material of claim 1, wherein the adhesion promoting layer is comprised of a combination of a polyolefin and an acrylic.

16. The sheet material of claim 1, wherein the adhesion promoting layer is comprised of a combination of a chlorinated polyolefin and an acrylic.

17. The sheet material of claim 1, wherein the adhesion promoting layer is comprised of a first layer comprised of a chlorinated polyolefin and a second layer comprised of an acrylic.

18. A laminate product, comprising:
a substrate;
a base coat layer adjacent to the substrate, the base coat layer comprising a colorant-containing thermoplastic resin system, the colorant being substantially uniformly distributed throughout the colorant-containing thermoplastic resin system;
a top coat layer; and
an adhesion promoting layer disposed between the base coat layer and the top coat layer.

19. The laminate product of claim 18, wherein the substrate is an automotive component.

20. The laminate product of claim 18, wherein the substrate is comprised of materials selected from the group consisting of thermoplastics, metals, and combinations thereof.

21. The laminate product of claim 18, wherein the base coat layer has an elongation at break in the range of up to about 500 as determined by ASTM D638.

22. The sheet material of claim 18, wherein the base coat layer is substantially opaque.

23. The sheet material of claim 18, wherein the colorant-containing thermoplastic resin system is comprised of materials selected from the group consisting of pigments, dyes, and combination thereof.

24. The sheet material of claim 18, wherein the colorant-containing thermoplastic resin system is comprised of a polyolefin.

25. The sheet material of claim 18, wherein the colorant-containing thermoplastic resin system is comprised of polypropylene.

26. The sheet material of claim 18, wherein the top coat layer is substantially transparent.

27. The sheet material of claim 18, wherein the top coat layer is scratch resistant.

28. The sheet material of claim 18, wherein the top coat layer is comprised of a thermoplastic material.

29. The sheet material of claim 18, wherein the top coat layer is comprised of polyvinylidene fluoride.

30. The sheet material of claim 18, wherein the top coat layer is comprised of polyurethane.

31. The sheet material of claim 18, wherein the top coat layer is comprised of cross-linked polyurethane.

32. The sheet material of claim 18, wherein the adhesion promoting layer is comprised of a polyolefin.

33. The sheet material of claim 18, wherein the adhesion promoting layer is comprised of a chlorinated polyolefin.

34. The sheet material of claim 18, wherein the adhesion promoting layer is comprised of a combination of a polyolefin and an acrylic.

35. The sheet material of claim 18, wherein the adhesion promoting layer is comprised of a combination of a chlorinated polyolefin and an acrylic.

36. The sheet material of claim 18, wherein the adhesion promoting layer is comprised of a first layer comprised of a chlorinated polyolefin and a second layer comprised of an acrylic.

37. A protective and decorative sheet material for application to substrates, comprising:
a base coat layer comprising:
a colorant-containing thermoplastic resin system, the colorant being substantially uniformly distributed throughout the colorant-containing thermoplastic resin system, and
a chlorinated compound applied to at least a portion of at least one surface of the base coat layer; and
a top coat layer disposed on the at least one surface of the base coat layer having the chlorinated compound applied thereto.

38. A protective and decorative sheet material for application to substrates, comprising:
a base coat layer comprising:
a colorant-containing thermoplastic resin system, the colorant being substantially uniformly distributed throughout the colorant-containing thermoplastic resin system, and
a chlorinated compound mixed throughout the colorant-containing thermoplastic resin system; and
a top coat layer disposed on the base coat layer.

39. A laminate product, comprising:
a substrate;
a base coat layer adjacent to the substrate, the base coat layer comprising a colorant-containing thermoplastic resin system, the colorant being substantially uniformly distributed throughout the colorant-containing thermoplastic resin system;
a chlorinated compound applied to at least a portion of at least one surface of the base coat layer; and
a top coat layer disposed on the at least one surface of the base coat layer having the chlorinated compound applied thereto.

40. A laminate product, comprising:
a substrate;
a base coat layer adjacent to the substrate, the base coat layer comprising:
a colorant-containing thermoplastic resin system, the colorant being substantially uniformly distributed throughout the colorant-containing thermoplastic resin system, and
a chlorinated compound mixed throughout the colorant-containing thermoplastic resin system; and
a top coat layer disposed on the base coat layer.

41. A method of making a protective and decorative sheet material for application to a substrate, comprising the steps of:
providing a base coat layer comprising a colorant-containing thermoplastic resin system, the colorant being substantially uniformly distributed throughout the colorant-containing thermoplastic resin system;
providing an adhesion promoting layer;
laminating the adhesion promoting layer onto the base coat layer;
providing a top coat layer; and
laminating the top coat layer onto the adhesion promoting layer.

42. A method of making a protective and decorative sheet material for application to a substrate, comprising the steps of:
providing a base coat layer comprising:
a colorant-containing thermoplastic resin system, the colorant being substantially uniformly distributed throughout the colorant-containing thermoplastic resin system, and
a chlorinated compound applied to at least a portion of at least one surface of the base coat layer;
providing a top coat layer; and
laminating the top coat layer onto the at least one surface of the base coat layer having the chlorinated compound applied thereto.

43. A method of making a protective and decorative sheet material for application to a substrate, comprising the steps of:
providing a base coat layer comprising:
a colorant-containing thermoplastic resin system, the colorant being substantially uniformly distributed throughout the colorant-containing thermoplastic resin system, and
a chlorinated compound mixed throughout the colorant-containing thermoplastic resin system;
providing a top coat layer; and
laminating the top coat layer onto the base coat layer.

44. A method of making a laminate product, comprising the steps of:
providing a base coat layer comprising a colorant-containing thermoplastic resin system, the colorant being substantially uniformly distributed throughout the colorant-containing thermoplastic resin system;
providing an adhesion promoting layer;
laminating the adhesion promoting layer onto the base coat layer;
providing a top coat layer;
laminating the top coat layer onto the adhesion promoting layer to form a laminate product;
providing a substrate; and
joining the laminate product to the substrate.

45. The method of claim 44, wherein the step of joining the laminate product to the substrate comprises methods selected from the group consisting of thermoforming, vacuum forming, insert molding, and combinations thereof.

46. The method of claim 44, wherein the substrate is selected from the group consisting of exterior automotive body panels, exterior automotive trim parts, and combinations thereof.

47. A method of making a laminate product, comprising the steps of:
providing a base coat layer comprising:
a colorant-containing thermoplastic resin system, the colorant being substantially uniformly distributed throughout the colorant-containing thermoplastic resin system, and
a chlorinated compound applied to at least a portion of at least one surface of the base coat layer;
providing a top coat layer;
laminating the top coat layer onto the at least one surface of the base coat layer having the chlorinated compound applied thereto to form a laminate product;
providing a substrate; and
joining the laminate product to the substrate.

48. The method of claim 47, wherein the step of joining the laminate product to the substrate comprises methods selected from the group consisting of thermoforming, vacuum forming, insert molding, and combinations thereof.

49. The method of claim 47, wherein the substrate is selected from the group consisting of exterior automotive body panels, exterior automotive trim parts, and combinations thereof.

50. A method of making a laminate product, comprising the steps of:
providing a base coat layer comprising:
a colorant-containing thermoplastic resin system, the colorant being substantially uniformly distributed throughout the colorant-containing thermoplastic resin system, and
a chlorinated compound mixed throughout the colorant-containing thermoplastic resin system;
providing a top coat layer;
laminating the top coat layer onto the base coat layer to form a laminate product;
providing a substrate; and
joining the laminate product to the substrate.

51. The method of claim 50, wherein the step of joining the laminate product to the substrate comprises methods selected from the group consisting of thermoforming, vacuum forming, insert molding, and combinations thereof.

52. The method of claim 50, wherein the substrate is selected from the group consisting of exterior automotive body panels, exterior automotive trim parts, and combinations thereof.
